(19) United States
(12) Patent Application Publication
(10) Pub. No.: US 2014/0204088 A1
(43) Pub. Date: Jul. 24, 2014

(54) SURFACE CODEC USING REPROJECTION ONTO DEPTH MAPS

(71) Applicant: MICROSOFT CORPORATION, Redmond, WA (US)

(72) Inventors: Adam Garnet Kirk, Renton, WA (US); Philip Andrew Chou, Bellevue, WA (US); Patrick John Sweeney, III, Woodinville, WA (US); Jizheng Xu, Beijing (CN)

(73) Assignee: MICROSOFT CORPORATION, Redmond, WA (US)

(21) Appl. No.: 13/744,885

(22) Filed: Jan. 18, 2013

(51) Int. Cl. G06T 3/00

(52) U.S. Cl. CPC G06T 3/0037
USPC 345/427

(57) ABSTRACT

A surface reprojection codec and method for surface compression using non-redundant surface projection onto depth maps. A multiple depth map encoder takes a two-dimensional (2D) surface that is a representation of a three-dimensional (3D) object and divides it into a plurality of surface patches. Each of these surface patches is projected onto a depth map from a set of depth maps. This generates a set of converted depth maps. This set of converted depth maps then are encoded using standard encoding techniques. The encoded version of the 3D object may be stored, transmitted over a network, or both. A multiple depth map decoder decodes the set of converted depth maps to obtain the surface patches. These surface patches and connectivity information can be used to regenerate the 2D surface. The 2D surface in turn can be used to reconstruct the 3D object.

### BACKGROUND

In computer graphics a surface (or “mesh”) is used to represent a three-dimensional (3D) object. Generally a mesh is a 2D surface that is embedded the 3D object and the accompanying connectivity information. This is known as the mesh geometry and the mesh connectivity. More specifically, a mesh is a set of vertices, edges, and faces of a 2D surface along with their connectivity relationships.

Geometric data for 3D objects as represented by a surface or mesh often is prohibitively large for both storage and transmission. Thus, it is desirable and advantageous to compress this data prior to storage and transmission. One current mesh compression technique is volumetric compression, typically in a hierarchical structure. This technique compresses a file and then splits the compressed file into different parts. However, volumetric compression is unable to leverage existing image compression mechanisms. Another type of mesh compression technique is to cut and reparameterize the mesh onto a completely regular structure called a geometry image. However, this is time-consuming and tends to add distortion.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the surface reprojection codec and method encode and decode a 2D surface that is a representation of a 3D object. This encoding and decoding of the 2D surface is achieved by projecting the 2D surface onto depth maps. A depth map in 3D computer graphics is an image or image channel containing information about the distance between the captured 3D object and a camera viewpoint. The viewpoint may be an actual camera or may be a virtual camera viewpoint. The depth maps then are encoded using standard encoding techniques. In other words, the 2D surface is encoded by leveraging depth maps. This yields an encoded version of the 3D surface.

Embodiments of the codec and method include 2D surface encoding and decoding that is fast, efficient, and leverages existing codec techniques. Embodiments of the codec and method project a surface geometry of the 2D surface onto a set of depth maps such that no surface is encoded in more than one depth map. The encoder part of the codec and method first divide or discretize the 2D surface into a plurality of surface patches. These surface patches may be uniform or any combination of a variety of sizes and shapes. The surface patches then are projected onto a set of depth maps in any one or more of four different ways. This produces a set of converted depth maps containing the surface patches projected onto the depth maps. The set of converted depth maps then is encoded using standard encoding techniques. The resulting encoded 3D object can be stored, transmitted over a network, or both.

The decoder portion of the codec and method receives an encoded set of depth maps from the encoder and decodes them. This yields decoded converted depth maps containing the surface patches projected onto the depth maps. These depth maps are converted back into the surface patches and the 2D surface is regenerated. The resultant 2D surface can be used to reconstruct the 3D object.

Connectivity information is used to connect the surface patches back together in order to obtain the 2D surface. In some embodiments the connectivity information is obtained by embodiments of the encoder and transmitted as side information with the encoded 3D object. In other embodiments the connectivity information is obtained during the decoding by using an optimization function.

In some embodiments of the codec and method multiple surface patches will project onto the same position in the same depth map. In this instance each surface patch is projected onto a separate depth maps and a layered ordering is used. The layered ordering dictates the ranking of each of the depth maps at the given position. In some embodiments this is determined by a distance from the position to the virtual camera viewpoint. Those depth maps having a smaller distance are on top as compared to those depth maps having a larger distance.

It should be noted that alternative embodiments are possible, and steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of the surface reprojection codec and method implemented in a computing environment.

FIG. 2 is a block diagram illustrating the system details of the multiple depth map encoder shown in FIG. 1.

FIG. 3 is a block diagram illustrating the system details of the multiple depth map decoder shown in FIG. 1.

FIG. 4 illustrates a simplified example of a general-purpose computer system on which various embodiments and elements of the surface reprojection codec and method, as described herein, may be implemented.

FIG. 5 is a flow diagram illustrating the general operation of the multiple depth map encoder shown in FIGS. 1 and 2.

FIG. 6 is a flow diagram illustrating the general operation of the multiple depth map decoder shown in FIGS. 1 and 3.

FIG. 7 is a flow diagram illustrating the operation of a first embodiment of the projection module shown in FIG. 2.

FIG. 8 is a flow diagram illustrating the operation of a second embodiment of the projection module shown in FIG. 2.

FIG. 9 is a flow diagram illustrating the operation of a third embodiment of the projection module shown in FIG. 2.

FIG. 10 is a flow diagram illustrating the operation of a fourth embodiment of the projection module shown in FIG. 2.

FIG. 11 is a flow diagram illustrating the operation of the ordering module shown in FIG. 2.

### DETAILED DESCRIPTION

In the following description of the surface reprojection codec and method reference is made to the accompanying drawings, which form a part thereof, and in which is shown by way of illustration a specific example whereby embodiments of the surface reprojection codec and method may be practiced. It is to be understood that other embodiments may be utilized and structural changes may be made without departing from the scope of the claimed subject matter.

### I. System Overview

Embodiments of the surface reprojection codec and method provide fast and efficient surface compression using non-redundant surface projection onto depth maps. A “codec” is a device or computer program capable of both encoding and decoding. Reprojection of the surface means that the surface may be transformed into a different coordinate system in the form of the depth maps.

Some embodiments of the system and method project a surface geometry onto a set of depth maps such that no piece of the surface is encoded in more than a single depth map. In other embodiments there may be overlap. The depth maps then are encoded using standard video encoding techniques. Depth map locations are selected to minimize the encoded size and reduce reprojection errors. Moreover, any discontinuities in the encoding blocks are represented explicitly.

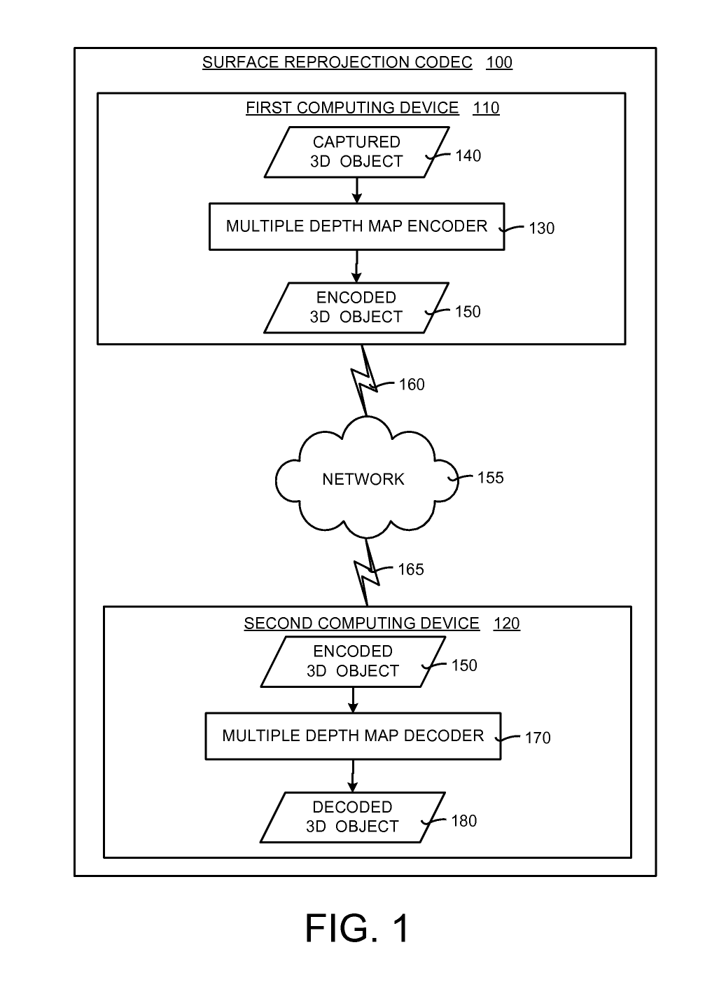

FIG. 1 is a block diagram illustrating a general overview of embodiments of the surface reprojection codec 100 and method implemented in a computing environment. As shown in FIG. 1, the codec 100 and method are shown implemented on a first computing device 110 and a second computing device 120. In some embodiments these computing devices may be a single computing device or may be spread out over a plurality of computing devices. Regardless of the embodiment, a computing device may be virtually any device having a processor, including a desktop computer, a tablet computing device, and an embedded computing device.

The embodiment shown in FIG. 1 includes a multiple depth map encoder 130 residing on the first computing device 110. A captured three-dimensional (3D) object 140 is input to the multiple depth map encoder 130. The captured 3D object 140 is a digital capture of the 3D object by using, for example, a camera or a video camera. In addition, the captured 3D object may be from a virtual camera viewpoint obtained through the use of software and multiple cameras. The virtual camera viewpoint is a viewpoint that cannot be achieved with a single camera but uses multiple cameras to obtain the viewpoint.

The output from the multiple depth map encoder 130 is the encoded 3D object 150. As explained in detail below, this encoded 3D object 150 can be stored in a digital storage device. Moreover, the encoded 3D object 150 can be transmitted over a network 155 to another device, such as the second computing device 120. This is achieved by sending the encoded 3D object 150 through a first communication link 160 that links the first computing device 110 and the network 155. The encoded 3d object 150 is transmitted from the network 155 to the second computing device 120 through a second communication link 165.

The embodiment shown in FIG. 1 also includes a multiple depth map decoder 170 residing on the second computing device 120. The encoded 3D object 150 is input to the multiple depth map decoder 170. The multiple depth map decoder 170 processes the encoded 3D object 150 and output the decoded 3D object 180. This decoding process is discussed in further detail below.

### II. System Details

Embodiments of the codec 100 and method include a variety of components, devices, and systems that work together to perform surface compression in a fast and efficient manner. The components, systems, and devices will now be discussed. It should be noted that other embodiments are possible and that other components, systems, and devices may be used or substituted to accomplish the purpose and function of the components, systems, and devices discussed.

### II.A. Multiple Depth Map Encoder

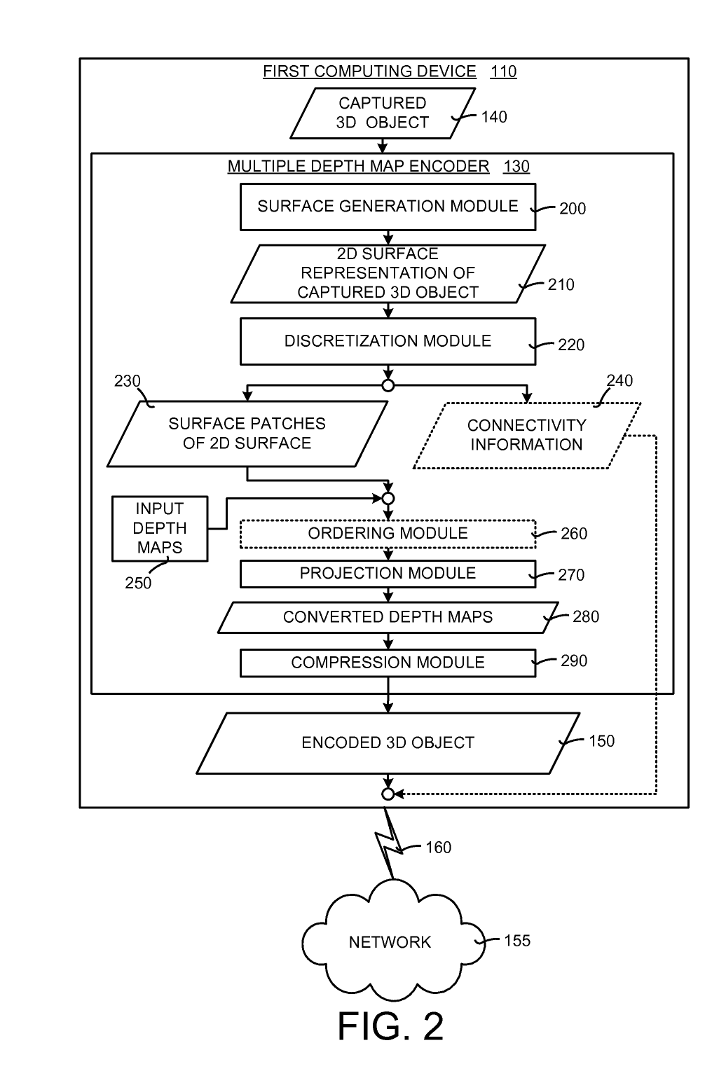

FIG. 2 is a block diagram illustrating the system details of the multiple depth map encoder 130 shown in FIG. 1. As shown in FIG. 2, the multiple depth map encoder 130 is implemented on the first computing device 110 and receives an input the captured 3D object 140. The multiple depth map encoder 130 includes a surface generation module 200 for generating a two-dimensional (2D) surface 210. The 2D surface 210 is a representation of the captured 3D object 140.

The multiple depth map encoder 130 also includes a discretization module 220 for dividing the 2D surface 210 into a plurality of surface patches 230. Each surface patch is a small piece of the 2D surface 210 such that the sum of the surface patches 230 equals the entire 2D surface 210.

Some embodiments of the multiple depth map encoder 130 include connectivity information 240. This is an optional component as depicted by the dotted lines. The connectivity information 240 describes how the surface patches 230 or depth maps that represent the surface patches are connected to each other in order to generate the entire 2D surface 210. In other embodiments the connectivity information 240 is determined by solving an optimization function during the decoding process.

Embodiments of the multiple depth map encoder 130 make use of a set of input depth maps 250. As explained in detail below, this set of input depth maps is used to receive the reprojection of surface patches 230. Some embodiments of the multiple depth map encoder 130 also include an ordering module 260. This optional module (as depicted by the dotted lines) is used when it is determined that more than one of the surface patches projects onto a same position in a same depth map. In this situation, the ordering module 260 is used for using a layered ordering technique that dictates an order of the surface patches 230. In other words, which surface patches 230 are on top and which are on the bottom.

Embodiments of the multiple depth map encoder 130 also include a projection module 270 for projecting the plurality of surface patches 230. Once the surface patches 230 are projected onto the depth maps 250, this results in converted depth maps 280. These converted depth maps 280 are compressed using a compression module 290. The output of the multiple depth map encoder 130 is the encoded 3D object 150. This encoded 3D object 150 may be stored and transmitted over the network 155.

### II.B. Multiple Depth Map Decoder

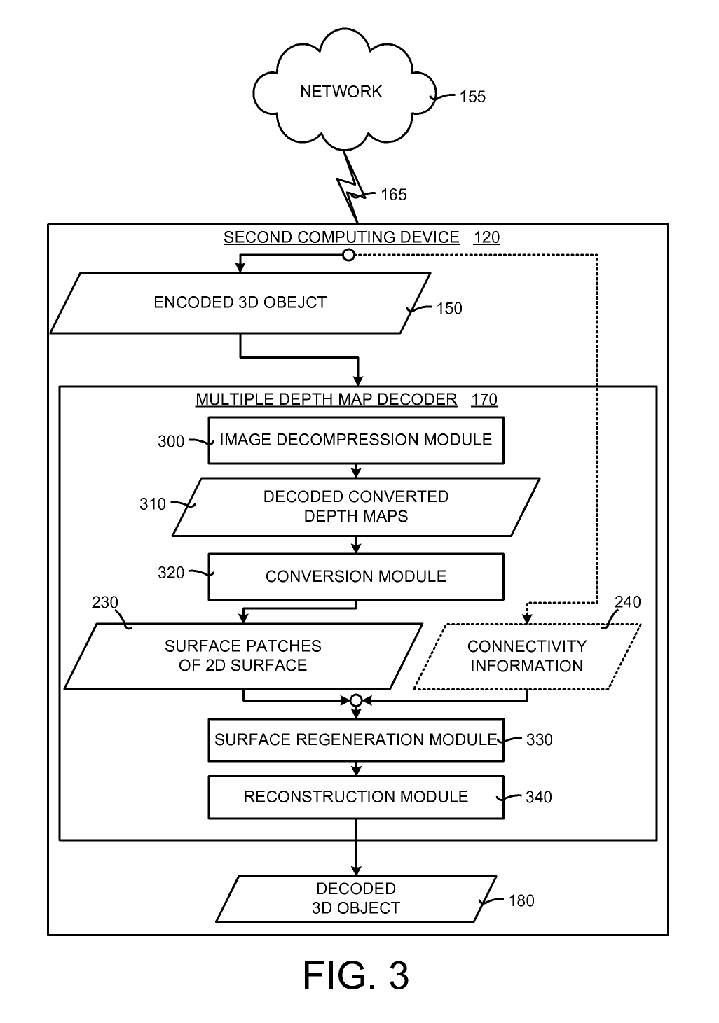

FIG. 3 is a block diagram illustrating the system details of the multiple depth map decoder 170 shown in FIG. 1. As shown in FIG. 3, the multiple depth map decoder 170 is implemented on the second computing device 120 and receives an input the encoded 3D object 150. In some embodiments of the multiple depth map decoder 170 the encoded 3D object 150 is received over the network 155 through the second communication link 165.

As shown in FIG. 3, embodiments of the multiple depth map decoder 170 include a decompression module 300 that receives and processes the encoded 3D object 150. The decompression module 300 decodes the depth maps contained in the encoded 3D object 150 and outputs decoded set of converted depth maps 310. Embodiments of the multiple depth map decoder 170 also include a conversion module 320 for converting the set of converted depth maps 280 into the plurality of surface patches 230.

In some embodiments the multiple depth map decoder 170 receives the connectivity information 240 that has been transmitted over the network 155. This is shown as optional by the dotted lines. In other embodiments the multiple depth map decoder 170 uses one or more optimization functions to determine the connectivity information 240 and the connectivity information is not transmitted over the network 155.

Embodiments of the multiple depth map decoder 170 also include a surface regeneration module 330 that takes the plurality of surface patches 230 and the connectivity information 240 (that was either transmitted over the network 155 or obtained using optimization functions) and assembles them to obtain the 2D surface 210. Embodiments of the multiple depth map decoder 170 also include a reconstruction module 340 for using the 2D surface 210 to recover the decoded 3D object 180. The decoded 3D object is output from embodiments of the multiple depth map decoder 170.

### III. Exemplary Operating Environments

Before proceeding further with the operational overview and details of embodiments of the surface reprojection codec 100 and method, a discussion will now be presented of exemplary operating environments in which embodiments of the surface reprojection codec 100 and method may operate. Embodiments of the surface reprojection codec 100 and method described herein are operational within numerous types of general purpose or special purpose computing system environments or configurations.

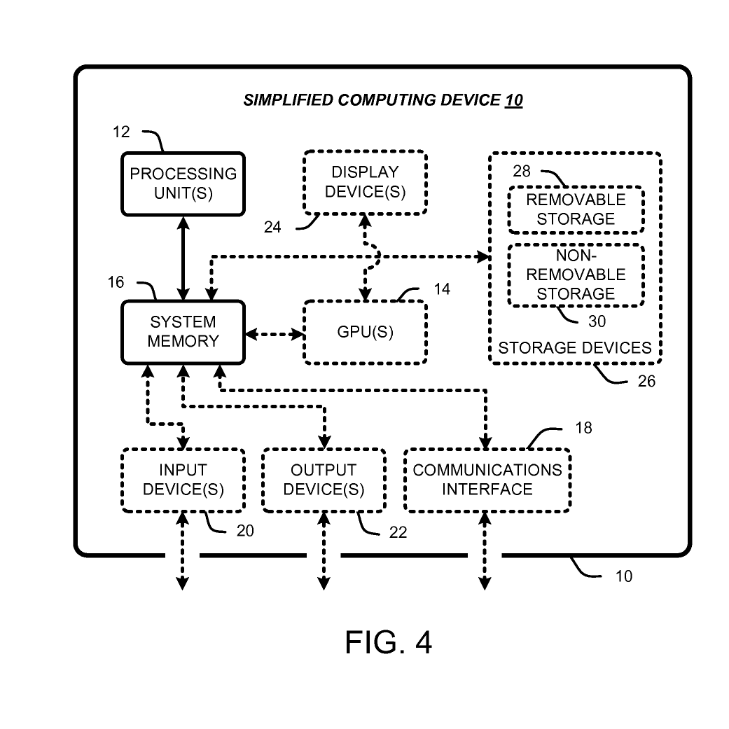

FIG. 4 illustrates a simplified example of a general-purpose computer system on which various embodiments and elements of the surface reprojection codec 100 and method, as described herein, may be implemented. It should be noted that any boxes that are represented by broken or dashed lines in FIG. 4 represent alternate embodiments of the simplified computing device, and that any or all of these alternate embodiments, as described below, may be used in combination with other alternate embodiments that are described throughout this document.

For example, FIG. 4 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement embodiments of the surface reprojection codec 100 and method described herein, the device should have a sufficient computational capability and system memory to enable basic computational operations. In particular, as illustrated by FIG. 4, the computational capability is generally illustrated by one or more processing unit(s) 12, and may also include one or more GPUs 14, either or both in communication with system memory 16. Note that that the processing unit(s) 12 of the general computing device may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 4 may also include other components, such as, for example, a communications interface 18. The simplified computing device of FIG. 4 may also include one or more conventional computer input devices 20 (e.g., pointing devices, keyboards, audio input devices, video input devices, haptic input devices, devices for receiving wired or wireless data transmissions, etc.). The simplified computing device of FIG. 4 may also include other optional components, such as, for example, one or more conventional display device(s) 24 and other computer output devices 22 (e.g., audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 4 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. Computer readable media may comprise computer storage media and communication media. Computer storage media refers to tangible computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying some or all of the embodiments of the surface reprojection codec 100 and method described herein, or portions thereof, may be stored, received, transmitted, or read from any desired combination of computer or machine readable media or storage devices and communication media in the form of computer executable instructions or other data structures.

Finally, embodiments of the surface reprojection codec 100 and method described herein may be further described in the general context of computer-executable instructions, such as program modules, being executed by a computing device. Generally, program modules include routines, programs, objects, components, data structures, etc., that perform particular tasks or implement particular abstract data types. The embodiments of the surface reprojection codec 100 and method described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### IV. Operational Overview

An operational overview of embodiments of the multiple depth map encoder 130 and the multiple depth map decoder 170 will now be presented. It should be noted that the following overview is merely illustrative of several ways in which embodiments of the encoder 130 and decoder 170 may operate.

### IV.A. Multiple Depth Map Encoder Operation

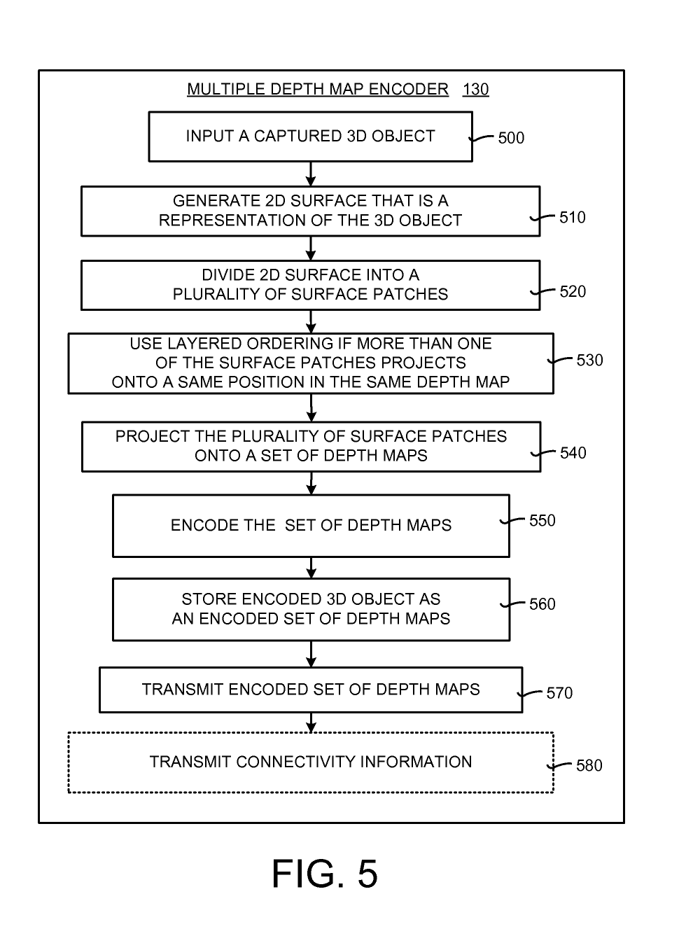

FIG. 5 is a flow diagram illustrating the general operation of the multiple depth map encoder 130 shown in FIGS. 1 and 2. As shown in FIG. 5, the operation of the encoder 130 begins by inputting a captured 3D object (box 500). As noted above, the captured 3D object is a digital image that has been captured by a camera, video camera, or a virtual camera using a plurality of cameras.

Embodiments of the encoder 130 then generate a 2D surface that is a representation of the captured 3D object (box 510). This 2D surface then is divide or discretized into a plurality of surface patches (box 520). The plurality of surface patches may be uniform triangles, groups of triangles with low curvatures, oriented points, or virtually any other shape. Moreover, the plurality of surface patches may be uniform in size and shape, uniform in shape with varying sizes, or have varying shapes and sizes.

Next a determination is made as to whether more than one surface patch projects onto an identical position in the same depth map. If so, then embodiments of the encoder 130 use layered ordering to determine a hierarchy of layering (box 530). Each of the plurality of surface patches then is projected onto a set of depth maps (box 540). A depth map in 3D computer graphics is an image or image channel containing information about the distance between the captured 3D object and a camera viewpoint. The viewpoint may be an actual camera or may be a virtual camera viewpoint. The result of this projection of surface patches onto depth maps is the set of converted depth maps 280.

Embodiments of the encoder 130 then encode each depth map in the set of converted depth maps (box 550). In some embodiments of the encoder 130 this compression is performed using one or more standard encoding techniques. Moreover, in some embodiments the encoded 3D object is stored as an encoded set of depth maps (box 560). In some embodiments the encoded 3D object is transmitted over the network as the encoded set of depth maps (box 570).

In some embodiments the connectivity information is obtained when the 2D surface is discretized into a plurality of surface patches. In this case the connectivity information is transmitted as side information over the network along with the encoded set of depth maps (box 580). This is an optional event as depicted by the dotted lines. As explained below, in other embodiments the connectivity information is not transmitted but is determined during the decoding process.

### IV.B. Multiple Depth Map Decoder Operation

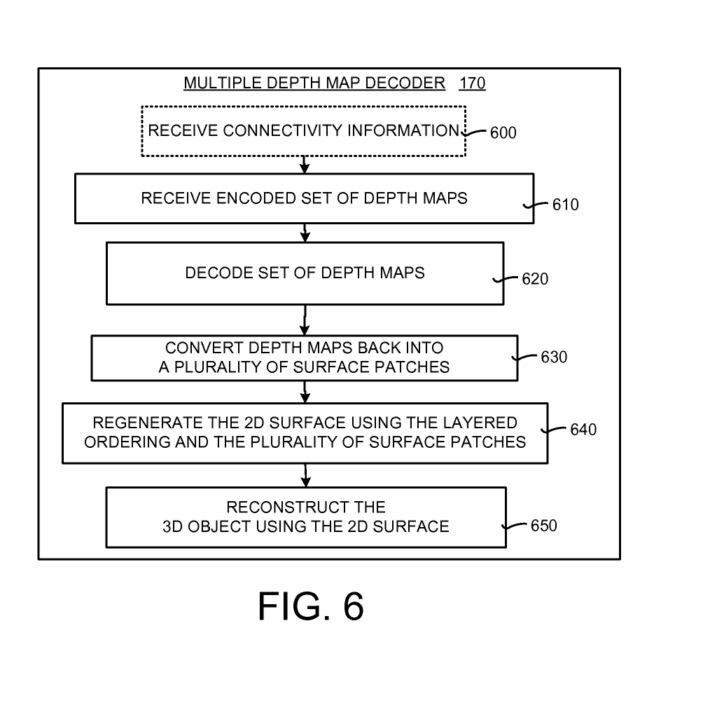

FIG. 6 is a flow diagram illustrating the general operation of the multiple depth map decoder 170 shown in FIGS. 1 and 3. As shown in FIG. 6, in some embodiments the connectivity information is transmitted as side information over the network and received by embodiments of the decoder 170 (box 600). This is an optional event as depicted by the dotted lines. Moreover, embodiments of the decoder 170 receive the encoded set of depth maps that have been transmitted over the network box 610).

Embodiments of the decoder 170 then decode the encoded set of depth maps (box 620). This generates a decoded set of converted depth maps containing the surface patch projections. Embodiments of the decoder 170 then process the converted depth maps back into the plurality of surface patches (box 630). The plurality of surface patches and the connectivity information then are used to regenerate the 2D surface (box 640).

As noted above the connectivity information may be transmitted as side information or embodiments of the decoder 170 may have to solve optimization functions in order to find the connectivity information. Regardless of how it is obtained, the plurality of surface patches are put back together based on the connectivity information. In addition, in some embodiments there may be overlapping surface patches and the layered ordering is used to determine how the surface patches are layered upon each other. Embodiments of the decoder 170 then reconstruct the 3D object using the 2D surface (box 650). At this point the decoding is complete and the captured 3D object is recovered.

### V. Operational Details

The operational details of embodiments of the select components of the surface reprojection codec 100 and method will now be presented. This includes the details of embodiments of the projection module 270 and embodiments of the optional ordering module 260.

### V.A. Projection Module

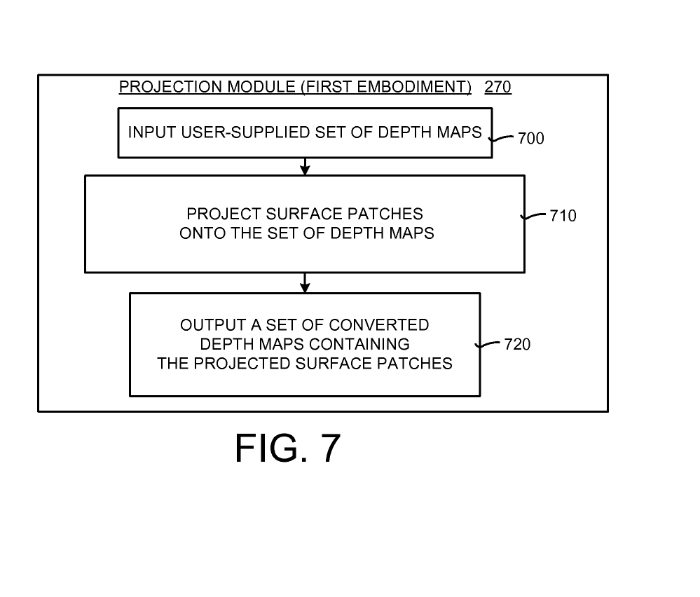

Embodiments of the projection module 270 are used to project the plurality of surface patches onto each of the set of depth maps. There are at least four different embodiments that the projection module 270 may use. FIG. 7 is a flow diagram illustrating the operation of a first embodiment of the projection module 270 shown in FIG. 2. As shown in FIG. 7, the operation begins by input a user-supplied set of depth maps (box 700). In other words, this set of depth maps are depth maps that the user has selected and feels would be suitable for use with the surface reprojection codec 100 and method.

Next the first embodiment of the projection module 270 project the plurality of surface patches onto the set of depth maps (box 710). In some embodiments this is done by projecting a single surface patch onto a single depth map. In other embodiments some of the surface patches may overlap. In each of these embodiments, when this process is completed, a converted set of depth maps containing the projected surface patches is output from the first embodiment of the projection module 270 (box 720).

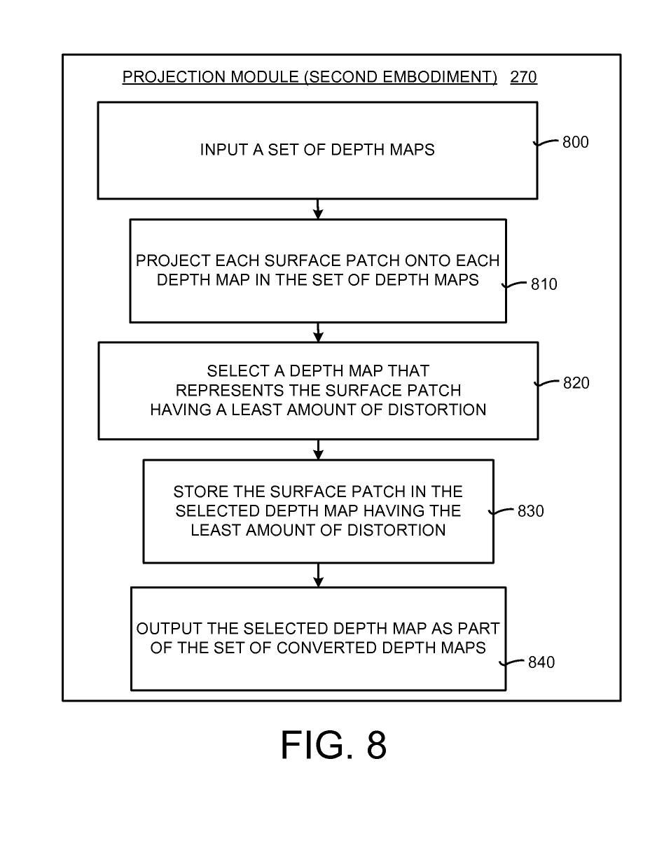

FIG. 8 is a flow diagram illustrating the operation of a second embodiment of the projection module 270 shown in FIG. 2. As shown in FIG. 8, the operation begins by inputting a set of depth maps (box 800). The second embodiment of the project module 270 then projects each surface patch onto each depth map in the set of depth maps (box 810).

A depth map then is selected that represents the surface patch having the least amount of distortion as compared to the other surface patches (box 820). The surface patch having the least amount of distortion for a given depth map then is stored in the selected depth map (box 830). The selected depth map then is output as part of the set of converted depth maps (box 840).

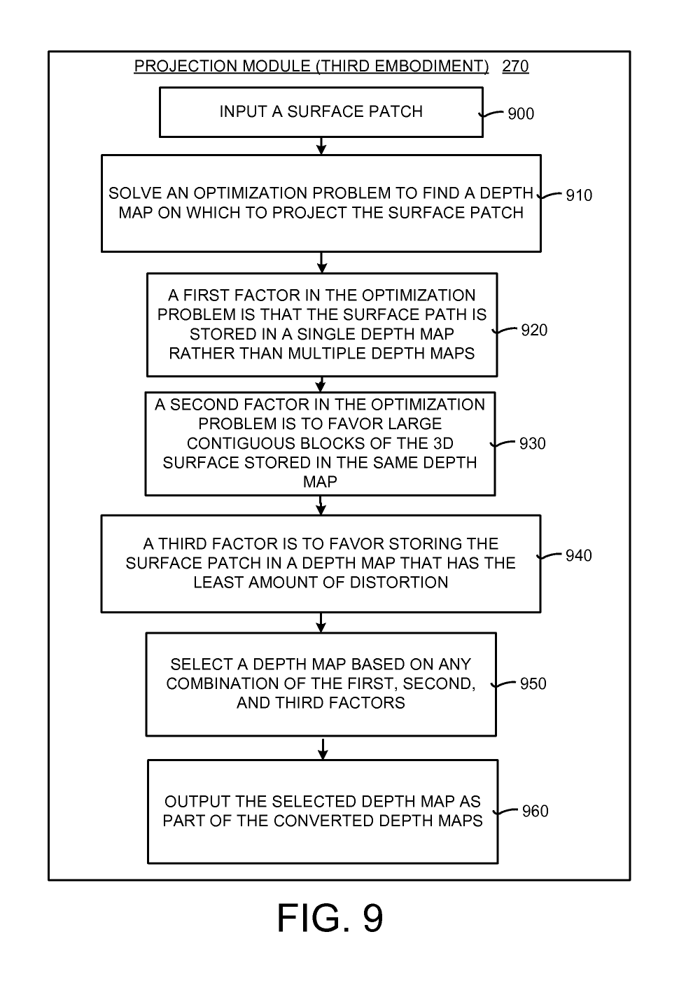

FIG. 9 is a flow diagram illustrating the operation of a third embodiment of the projection module 270 shown in FIG. 2. The operation begins by inputting a surface patch from the plurality of surface patches (box 900). Next, an optimization problem is solved in order to find a depth map on which to project the given surface patch (box 910). Several factors may be used to solve this optimization problem.

A first factor (or constraint) is that the given surface patch is stored in a single depth map rather than in a plurality of depth maps (box 920). A second factor (or constraint) is to favor large contiguous blocks of the 2D surface stored in the same depth maps (box 930). A third factor (or constraint) is to favor storing the surface patch in a depth map that has the least amount of distortion (box 940). All the while storing in the depth map that has the least amount of distortion.

In this third embodiment a depth map on which to project a surface patch may be selected based on any one or on any combination of the first, second, and third factors set forth above (box 950). The depth map then is output as part of the set of converted depth maps (box 960).

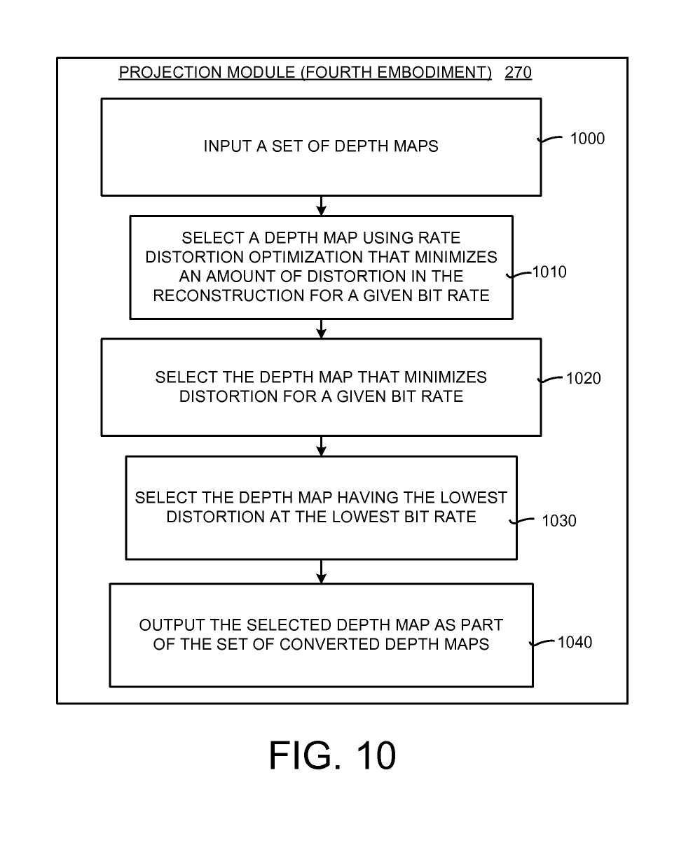

FIG. 10 is a flow diagram illustrating the operation of a fourth embodiment of the projection module 270 shown in FIG. 2. The operation begins by inputting a set of depth maps (box 1000). Next, a depth map is selected by using a rate distortion optimization technique (box 1010). This technique minimizes an amount of distortion in the reconstruction for a given bit rate. The guiding principle is to minimize the distortion while also minimizing the bit rate. Thus, high distortion and high bit rate are undesirable.

The fourth embodiment of the projection module 270 then selects the depth map that minimizes distortion for a given bit rate (box 1020). Moreover, the depth map selected is the depth map having the lowest distortion at the lowest bit rate (box 1030). The selected depth map is output as a part of the set of converted depth maps (box 1040).

### V.B. Ordering Module

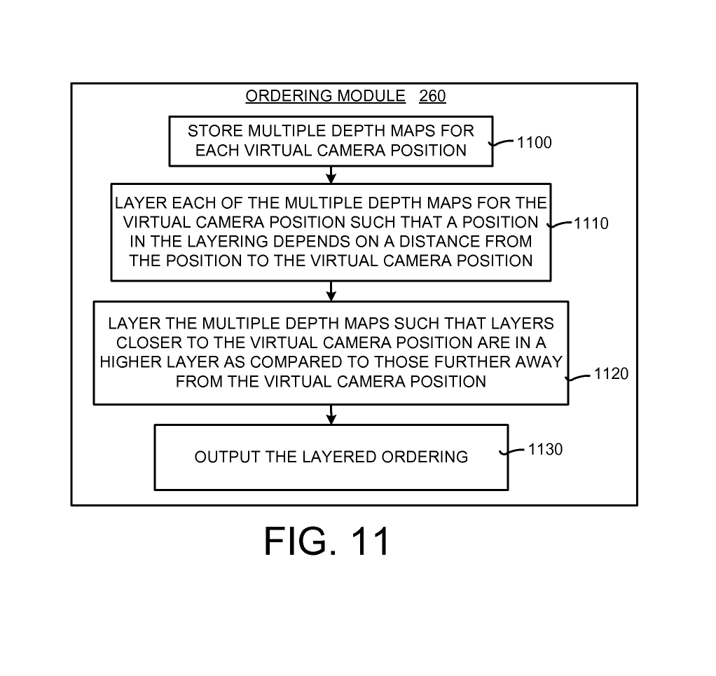

Embodiments of the optional ordering module 260 are used to determine an order of surface patches at locations where more than one surface patch overlaps on the 2D surface. FIG. 11 is a flow diagram illustrating the operation of the ordering module 260 shown in FIG. 2. The operation begins by storing multiple depth maps for each virtual camera position (box 1100). In other words, when there are multiple surface patches that project to the same location in the same depth map, then each of the surface patches projecting to the same location is stored in a different depth map.

A layered ordering then is determined such that a position of each of the multiple depth maps is assigned. In other words, the layered ordering determines whether a depth map goes behind another depth map or in front of another depth map. This layered ordering is performed by layering each of the multiple depth maps for a given virtual camera position such that a rank in the layering depends on a distance from the location on the 2D surface to the virtual camera position (box 1110).

Moreover, the layered ordering layers the multiple depth maps such that layers closer to the virtual camera position are in a higher layer (or ranked higher or closer to the virtual camera position) as compared to those depth maps further away from the virtual camera position (box 1120). Embodiments of the ordering module 260 then output the layered ordering (box 1130).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for compressing a two-dimensional surface, comprising:
generating the two-dimensional surface that is a representation of a digital three-dimensional object;
dividing the two-dimensional surface into a plurality of surface patches; and
projecting the plurality of surface patches onto a set of depth maps to obtain a set of converted depth maps; and
encoding the set of converted depth maps using a first computing device to obtain a compressed three-dimensional object.

2. The method of claim 1, further comprising projecting each one of the plurality of surface patches in no more than one depth map from the set of depth maps.

3. The method of claim 1, further comprising encoding the set of converted depth maps using at least one encoding techniques.

4. The method of claim 1, further comprising storing the compressed three-dimensional object as a compressed set of converted depth maps.

5. The method of claim 1, further comprising inputting the set of depth maps that are supplied by a user.

6. The method of claim 1, further comprising selecting a depth map from the set of depth maps that will represent a particular a surface patch with a least amount of distortion as compared to other depth maps in the set of depth maps.

7. The method of claim 1, further comprising solving an optimization problem to determine which depth maps from the set of depth maps on which to project a surface patch.

8. The method of claim 7, further comprising solving the optimization problem using a first constraint that the surface patch is stored in a single depth map rather than multiple depth maps.

9. The method of claim 7, further comprising solving the optimization problem using a second constraint that is to favor having large contiguous blocks of the surface patch stored in a same depth map.

10. The method of claim 7, further comprising solving the optimization problem using a third constraint of storing the surface patch in a depth map having a least amount of distortion as compared to other depth maps in the set of depth maps.

11. The method of claim 7, further comprising solving the optimization problem using a fourth constraint of selecting a depth map having a lowest amount of distortion for a given bit rate.

12. The method of claim 1, further comprising:
transmitting the compressed set of converted depth maps over a network from the first computing device to a second computing device; and
transmitting connectivity information along with the compressed set of converted depth maps to aid in decoding.

13. A surface compression reprojection system, comprising:
a general-purpose computing device;
a computer program that is executable by the general-purpose computing device, further comprising:
an encoder for encoding a two-dimensional surface, the encoder further comprising:
a surface generation module for generating the two-dimensional surface representing a digital three-dimensional object;
a discretization module for dividing the two-dimensional surface into a plurality of surface patches;
a projection module for projecting the plurality of surface patches onto a set of depth maps to obtain a set of converted depth maps such that no surface patch is projected onto more than one depth map; and
a compression module for encoding the converted depth maps using at least one encoding technique to obtain a compressed set of converted depth maps.

14. The surface compression reprojection system of claim 13, further comprising connectivity information that describes how each converted depth map in the set of converted depth maps are connected to each other.

15. The surface compression reprojection system of claim 13, further comprising an ordering module for determining that more than one of the plurality of surface patches projects onto a same depth map and using a layered ordering such that a first surface patch at position of a virtual depth camera position that is further away from the virtual depth camera as compared to a second surface patch is placed behind the second surface patch when projecting the plurality of surface patches onto the set of depth maps.

16. The surface compression reprojection system of claim 13, further comprising:
a decoder for decoding the compressed set of converted depth maps, the decoder further comprising:
an image decompression module for decoding the compressed set of converted depth maps to obtain a decompressed converted depth maps;
a conversion module for converting the decompressed converted depth maps into converted surface patches of two-dimensional surface representation; and
a surface regeneration module for reconstructing the converted surface patches into a decompressed three-dimensional object.

17. A computer-readable storage medium having stored thereon computer-executable instructions for encoding and decoding a digital three-dimensional object, comprising:
generating a two-dimensional surface that is a representation of the digital three-dimensional object;
dividing the two-dimensional surface into a plurality of surface patches;
projecting the plurality of surface patches onto set of depth maps to obtain a converted set of depth maps;
encoding the converted set of depth maps to obtain an encoded set of depth maps;
storing the digital three-dimensional object as an encoded set of depth maps; and
decoding the encoded set of depth maps to obtain a decoded three-dimensional object.

18. The computer-readable storage medium of claim 17, further comprising:
decoding the encoded set of depth maps to obtain a decoded set of depth maps; and
converting the decoded set of depth maps back into a plurality of surface patches.

19. The computer-readable storage medium of claim 18, further comprising:
receiving connectivity information describing how each depth map in the set of encoded set of depth maps is connected to other depth maps;
regenerating the two-dimensional surface using the plurality of surface patches and the received connectivity information; and
reconstructing the digital three-dimensional object using the regenerated two-dimensional surface.

20. The computer-readable storage medium of claim 18, further comprising:
solving an optimization function to obtain connectivity information describing how each depth map in the set of encoded set of depth maps is connected to other depth maps;
regenerating the two-dimensional surface using the plurality of surface patches and the received connectivity information; and
reconstructing the digital three-dimensional object using the regenerated two-dimensional surface.
